(19) United States
(12) Patent Application Publication
(10) Pub. No.: US 2002/0159136 A1
(43) Pub. Date: Oct. 31, 2002

(54) Very low noise figure optical amplifier devices

(76) Inventors: Zhenguo Lu, Orleans (CA); Vincent So, Ottawa (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/819,748

(22) Filed: Mar. 29, 2001

Related U.S. Application Data
(60) Provisional application No. 60/254,856, filed on Dec. 13, 2000.

(51) Int. Cl. H01S 3/00

(52) U.S. Cl. 359/337.4; 359/349

(57) ABSTRACT

A very low noise figure optical amplifier is provided which includes a noise reduction apparatus as part of the structure of the optical amplifier. To improve the signal-to-noise ratio (SNR) of the amplified optical signal, the noise reduction apparatus makes use of the coherence of a coherent component of an amplified optical signal having a coherent signal power and the incoherence of an incoherent component of the amplified optical signal having an incoherent signal power. The amplified optical signal is split in two path signals with each path signal having the same intensity but a different phase. The optical path length the path signals is selected such that coherent path components are combined constructively at a main output while the power of the incoherent path components is divided between the main output and at least one subsidiary output. The result is an increase in the SNR, and a decrease in noise figure (NF) of approximately 3 dB.

This application claims the benefit of U.S. Provisional Patent Application Serial No. 60/254,856 filed Dec. 13, 2000.

### FIELD OF THE INVENTION

This invention relates generally to optical communications systems. More specifically, the invention relates to optical amplifiers in communications systems.

### BACKGROUND OF THE INVENTION

In optical systems the signal-to-noise ratio (SNR) of an optical signal tends to degrade as it propagates through optical media such as optical wave-guides or optical fibers. The SNR of the optical signal may also degrade when the optical signal propagates through optical devices such as multiplexers. Opto-electronic regenerators can be used to improve the SNR of the optical signal but these devices are costly and inefficient. Erbium-doped fiber amplifiers (EDFAs) have been used to amplify weak optical signals without opto-electronic conversion. However, the amplification process adds noise causing SNR degradation. Noise performance in optical amplifiers is typically measured by the noise figure (NF) which is defined as the ratio of the SNR at the input of the optical amplifier to that at the output of the optical amplifier (NF=SNRᵢₙ/SNRₒᵤₜ). Under ideal conditions, a fiber amplifier may be fully inverted and the theoretical lower limit on the NF is 3 dB. This corresponds to the quantum limit of the NF. This quantum limit of the NF has limited the effectiveness of fiber amplifiers. Some optical amplifiers [R. A. Griffin, P. M. Lane, and J. J. O'Reilly, “Optical amplifier noise figure reduction for optical single-sideband signals,” Journal of Lightwave Technology, Vol.17, No.10, 1999, pp.1793-1796.] are used for NF reduction of optical single-sideband signals only and are not suited for other data-format signals and multi-channel optical signals. Other optical amplifiers [S. Lee, “Low-noise fiber-optic amplifier utilizing polarization adjustment,” U.S. Pat. No. 5,790,721, Aug. 4, 1998] [Y. C. Jung and C. H. Kim, “Optical Fiber Amplifer using Synchronized Etalon Filter”, U.S. Pat. No. 6,181,467, Jan. 30, 2000] [D. J. DiGivanni, J. D. Evankow, J. A. Nagel, R. G. Smart, J. W. Sulhoff, J. L. Zyskind, “High power, high gain, low noise, two-stage optical amplifier,” U.S. Pat. No. 5,430,572, Jul. 4, 1995.] have been developed to lower the NF but they are all constrained by the 3 dB quantum limit.

### SUMMARY OF THE INVENTION

A very low noise figure optical amplifier is provided which includes a noise reduction apparatus as part of the structure of the optical amplifier. To improve the signal-to-noise ratio (SNR) of the amplified optical signal, the noise reduction apparatus makes use of the coherence of a coherent component of an amplified optical signal having a coherent signal power and the incoherence of an incoherent component of the amplified optical signal having an incoherent signal power. The amplified optical signal is split in two path signals with each path signal having the same intensity but a different phase. The optical path length the path signals is selected such that coherent path components are combined constructively at a main output while the power of the incoherent path components is divided between the main output and at least one subsidiary output. The result is an increase in the SNR, and a decrease in noise figure (NF) of approximately 3 dB.

In another embodiment, a number, N, of such noise reduction apparatuses are connected in series resulting in a decrease in NF of approximately 10Nlog2 dB. In another embodiment, a similar arrangement of N noise reduction apparatuses connected in series is provided. Each one of the N noise reduction apparatuses splits an input optical signal into M path signals and recombines them such that the amplified optical signal propagating through the N noise reduction apparatuses results in a decrease in NF of approximately 10NlogM dB. Another embodiment also includes a control mechanism as part of the optical amplifier for tuning its performance dynamically.

In accordance with one broad aspect of the invention, the invention provides a method of amplifying an input optical signal. The method includes amplifying the input optical signal which results in an amplified optical signal with a coherent component and an incoherent component. The method also includes splitting the amplified optical signal into M path signals each having a respective coherent path component and a respective incoherent path component. The number of path signals satisfies M≧2, and preferably M=2. A respective phase adjustment is applied to at least one, and preferably M−1 or M of the M path signals. The phase adjustments are applied such that, at a combination point, the coherent path components are combined constructively and each incoherent path component is substantially uncorrelated with each other incoherent path component. In addition, at the combination point, the M path signals are combined to produce a main output optical signal with an improved SNR of the amplified optical signal.

In some embodiments, the process of combining the M path signals may include coupling the M path signals together in a manner which produces the main output optical signal containing most of the coherent signal power and containing a fraction of the incoherent signal power, with the remaining incoherent signal power being diverted to one or more subsidiary outputs.

The phase adjustments may be achieved using any suitable technique. For example, the phase adjustments may be achieved by employing an optical path length difference, ΔLₒ, between any two path signals of the M path signals which substantially satisfies ΔLₒ>L_{c} wherein L_{c} is the coherence length of the incoherent path components of the M path signals. It is noted that the optical path length difference, ΔLₒ, is a function of physical path length difference and/or index of refraction difference, when present. The optical path length difference, ΔLₒ, may result from using different physical path lengths and/or using paths made of optical transmission media having different indices of refraction. Fine phase adjustments to one or more of the path signals may be applied using phase controllers such as heaters, or piezoelectric devices to name a few examples.

In some embodiments, the steps of splitting the amplified optical signal, performing the phase adjustment and combining the path signal may be performed N times where N≧2. In this case, the result may be a decrease in NF of approximately 10 NlogM dB.

The method may include applying a phase adjustment to every one of the M path signals. The optical path length difference, ΔLₒ, may be chosen to satisfy a symbol shift tolerance. Preferably, the phase adjustment may be performed such that the optical path length difference substantially satisfies ΔLₒ≦χC/ω wherein C is the speed of light, ω is a carrier data rate of the input optical signal and χ is a symbol shift tolerance.

Preferably, the optical path length difference substantially satisfies ΔLₒ≦χC/ω where C is the speed of light in vacuum; ω is the data rate of the optical signals and χ is a fraction indicating a symbol shift in optical transmission to which the system is tolerant. For example, χ=0.2 indicates a 20% tolerance.

In some embodiments, the splitting, combining and phase adjustment are performed with a Mach-Zehnder or Michelson interferometer-based structure.

For multi-channel applications, the method is applied to an optical signal having a plurality of equally spaced channels wherein any two consecutive channels with wavelengths f′ and f of the equally spaced channels differ by Δf=f′−f. In addition, the optical path length difference, ΔLₒ, may satisfy ΔLₒ=KC/(2Δf), wherein K=1, 2, 3, . . . and C is the speed of light in vacuum.

In some embodiments, the method may include dynamically controlling the amplification of the input light signal to maximise the gain of the input optical signal without compromising the NF. In particular, the method may include dynamically controlling the phase adjustments to maximise the intensity of the output optical at the combination point. The method may also include amplifying the main output optical signal through a second amplification stage and the amplification of the main output optical signal may be controlled dynamically to maximise the gain of the input optical signal without compromising the NF of the optical amplifier.

Another broad aspect of the invention provides an optical amplifier that is used to amplify an input optical signal. The optical amplifier includes a amplification stage connected to a noise reduction apparatus. The amplification stage receives the input optical signal and amplifies it resulting in an amplified optical signal having a coherent component and an incoherent component. The noise reduction apparatus splits the amplified optical signal into M path signals, and preferably M=2. Each path signal has a coherent path component and an incoherent path component and the optical amplifier recombines the M path signals in a manner resulting in a decreased noise NF of the optical amplifier and an increased SNR of the optical signal. Each path of the path signals may be chosen such that an optical path length difference, ΔLₒ, between paths of any two path signal of the M path signals satisfies ΔLₒ>L_{c} wherein L_{c} is the coherence length of the incoherent path components.

In some embodiments, the noise reduction apparatus may have an input optical splitter connected to the amplification stage. The input optical splitter may be used to split the amplified optical signal into the M path signals. The input optical splitter might be a 1×M splitter or a M×M splitter in which case one of M inputs of the M×M splitter may be used to receive the amplified optical signal and remaining ones of the M inputs of the M×M splitter may be locally terminated. The noise reduction apparatus may have M optical transmission media, wherein each one of the M path signals propagates through a respective one of the M optical transmission media. The optical transmission media might be optical wave-guides and/or optical fibers. The noise reduction apparatus may have a phase controller in at least one, and preferably M−1 or M of the M optical transmission media in which case the phase controllers may be used to apply a phase adjustment to a respective one of the path signals. The phase controllers may have at least one heater adapted to introduce the phase adjustments by varying an index of refraction of a respective one of the optical transmission media through the application of heat. The phase controllers may also have at least one device for introducing the phase adjustments by applying at stretching force to at least one of the optical transmission media to change the physical length of the transmission medium. The device for introducing the phase adjustments through the stretching force may be a piezoelectric device. The noise reduction apparatus might include an output optical coupler adapted to couple the path signals into a main output optical signal and at least one subsidiary output optical signal. The main output optical signal may be output at a main output in such a way that all of the coherent path components are output at the main output. The subsidiary output optical signals may be output at one or more subsidiary outputs in such a way that the incoherent path components are substantially divided between the main output and the subsidiary outputs. The output optical coupler might be a M×M coupler such that one of M outputs of the M×M coupler is the main output and remaining ones of the M outputs are the subsidiary outputs.

A second amplification stage may be connected to an output of the noise reduction apparatus to form a two-stage optical amplifier. In this case, the second amplification stage might be used to amplify the main output optical signal.

In some embodiments, the optical amplifier may consist of a plurality of the noise reduction apparatuses arranged in a serial configuration.

In embodiments where the optical amplifier has two optical transmission media (M=2), the addition of the noise reduction apparatus to the optical amplifier results in a decrease in the NF of the optical amplifier of approximately 3 dB. The input optical splitter might be a 1×2 3-dB single-mode coupler or a 2×2 3-dB single-mode coupler in which case one of two inputs of the 2×2 3-dB single-mode coupler might be terminated locally. The output optical coupler might be a 2×2 3-dB single-mode coupler.

In some embodiments where there are two path signals (M=2), the noise reduction apparatus may have two reflectors each connected to a respective one of the optical transmission media. Each one of the reflectors may be used to reflect a respective one of the path signals. The noise reduction apparatus may also include an optical coupler connected to the optical transmission media such that the optical coupler receives the input optical signal and splits it into the path signals. The optical coupler may also be used to receive and couple the path signals that have been reflected by the reflectors. The reflectors may be fiber Bragg gratings or gold tip pig tail fiber reflectors and the optical coupler may be a 2×2 3-dB single-mode coupler.

The optical amplifier may include a control mechanism for tuning the performance of the optical amplifier. The control mechanism may include a control device connected to the amplification stage and to the noise reduction apparatus. The control device may be used to provide instructions to the amplification stage for controlling the amplification of the input optical signal and to provide instructions to the noise reduction apparatus for controlling phase adjustments of the path signals. The control mechanism may have an input tap coupler connected to the amplification stage and two power detectors (PDs) each connected to the input tap coupler and the control device. In this case, the input tap coupler may be used to provide an asymmetric split of the input light signal such that a significant fraction of the input light signal propagates to the amplification stage and a small fraction of the input light signal propagates to a respective one of the PDs. The input tap coupler may also be used to provide an asymmetric split of signal reflected at the gain block, that propagates through the input tap coupler is routed to a respective one of the two PDs. The input tap coupler may be a 2×2 asymmetric coupler. For example, it may be a 95:5%2×2 asymmetric coupler.

The control mechanism may include an output tap coupler connected to the noise reduction apparatus and a PD connected to the output tap coupler and the control device. The output tap coupler might be used to perform an asymmetric split of the output optical signal such that a significant fraction of the output optical signal propagates to an output of the optical amplifier and a small fraction of the output signal propagates to the PD of the output tap coupler. The PD of the output tap coupler may be used to convert the small fraction of the input signal into an electrical signal. The output tap coupler may be a 1×2 asymmetric coupler. For example, it might be a 99:1% 1×2 asymmetric coupler.

The control mechanism may include yet another PD connected to at least one subsidiary output of the noise reduction apparatus and to the control device. This PD may be used to convert a subsidiary optical signal into an electrical signal. Multi-stage amplifier embodiments may also be equipped with such a control mechanism.

### BRIEF DESCRIPTION OF THE DRAWINGS

Preferred embodiments of the invention will now be described with reference to the attached drawings in which:

FIGS. 1 to 4 are block diagrams illustrating noise reduction apparatuses for use in the amplifying circuit of FIG. 6;

FIG. 5 is a flow chart of the method used to increase the SNR of an optical signal;

FIG. 6 is a block diagram illustrating a very low noise figure optical amplifier provided by an embodiment of the invention;

FIG. 7 is a block diagram illustrating the optical amplifier of FIG. 6 with a control mechanism for tuning the performance of the optical amplifier of FIG. 6;

FIG. 8 is a block diagram illustrating a very low noise figure two-stage optical amplifier provided by another embodiment of the invention;

FIG. 9 is a block diagram illustrating the two-stage optical amplifier of FIG. 8 with a control mechanism for tuning the performance of the two-stage optical amplifier of FIG. 8; and

FIG. 10 is a block diagram illustrating an optical amplifier with a mechanism for tuning the performance of the optical amplifier provided by another embodiment of the invention.

### PREFERRED EMBODIMENTS

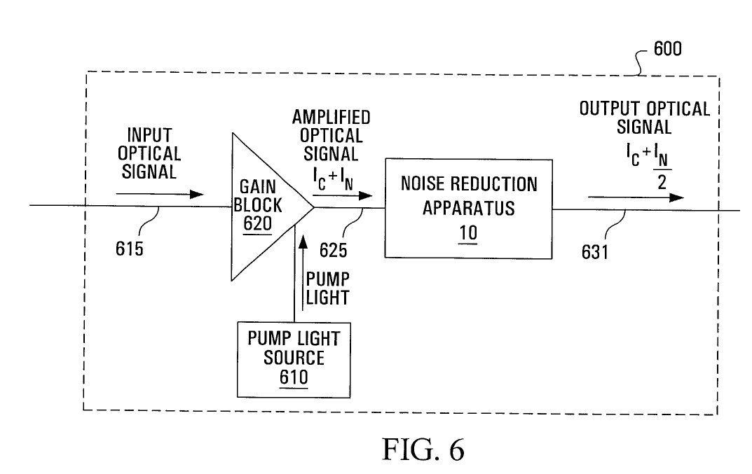

Referring to FIG. 6, shown is a schematic block diagram illustrating a very low noise figure (NF) optical amplifier 600 provided by an embodiment of the invention. The optical amplifier 600 has a main input 615 connected to the gain block 620. A pump light source 610 is connected to a gain block 620. An output of the gain block 620 is connected to an input of a noise reduction apparatus 10 through an optical transmission medium 625. The noise reduction apparatus 10 produces an output signal at a main output 631.

The pump light source 610 provides pump light to the gain block 620. An input optical signal input at the input 615 of the gain block 620 is amplified resulting in an amplified optical signal. As detailed below, the noise reduction apparatus reduces noise generated in any amplification stage which introduces an incoherent noise component. In the related embodiment, the amplification stage is the gain block 620 with pump light source 610, but it is to be understood that other amplification stages may alternatively be employed.

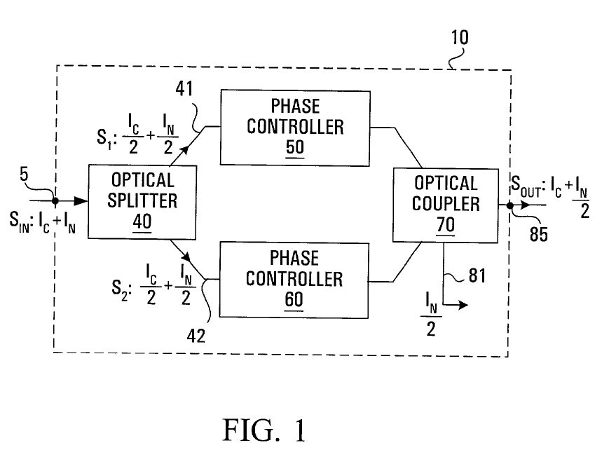

The amplified optical signal has a coherent component with intensity, I_{C}, which is an amplified version of a coherent component of the input optical signal and an incoherent component with intensity, I_{N}, due to noise in the input optical signal and amplified spontaneous emission (ASE) generated in the gain block 620. The amplified optical signal propagates to the noise reduction apparatus 10 where the signal-to-noise ratio (SNR) of the amplified optical signal is increased by a factor which depends upon the particulars of the noise reduction apparatus 10. Equivalently, with the addition of the noise reduction apparatus 10, the NF of the optical amplifier 600 is reduced. The noise reduction apparatus 10 may be any one of the noise reduction apparatuses described below with reference to FIGS. 1 to 4 and variants thereof. In a preferred embodiment of the invention, the noise reduction apparatus 10 corresponds to the noise reduction apparatus 10 of FIG. 1 and, consequently, the intensity of the incoherent component of the output optical signal is I_{N}/2 resulting in a reduction in NF of the optical amplifier 600 of approximately 3 dB with the addition of the noise reduction apparatus 10.

In order to achieve the best possible noise reduction performance using the optical amplifier 600 of FIG. 6, preferably a control circuit is provided which enables the optical amplifier 600 to be tuned. More specifically, any phase controllers in the noise reduction apparatus 10 may be adjusted so as to ensure the maximum amount of the coherent component of the amplified optical signal is output at the main output 631, while at the same time diverting noise power to subsidiary outputs (shown in FIGS. 1 to 4) of the noise reduction apparatus 10.

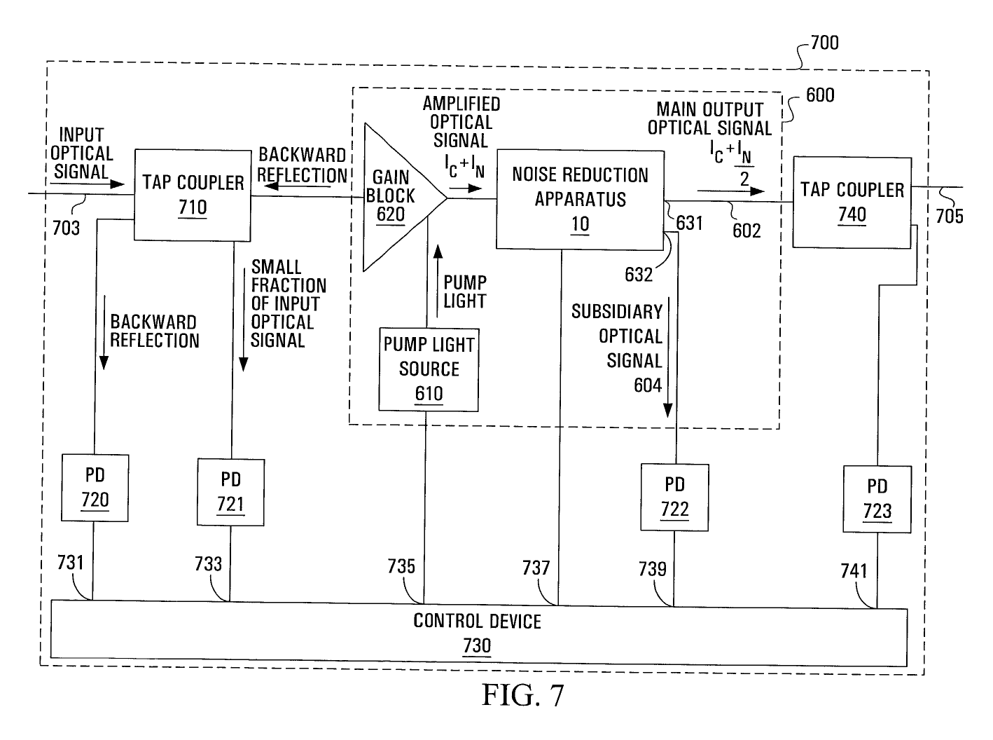

Referring to FIG. 7, shown is a schematic block diagram illustrating a very low NF optical amplifier 700 which includes the optical amplifier 600 of FIG. 6 and a control mechanism for tuning the performance of the optical amplifier 600. An input 703 of the optical amplifier 700 is connected to an input tap coupler 710. The input tap coupler 710 is connected to the input of the gain block 620 of the optical amplifier 600. The input tap coupler 710 is also connected to power detectors (PDs) 720 and 721. The PDs 720 and 721 are connected to respective inputs 731,733 of a control device 730. The control device 730 in one embodiment is a microprocessor, but more generally may be any device suitable designed and/or configured to perform analysis of signals output by the power detectors. The pump light source 610 of the optical amplifier 600 is connected to an output 735 of the control device 730. The noise reduction apparatus 10 of the optical amplifier 600 is connected to an output 737 of the control device 730. A subsidiary output 632 of the noise reduction apparatus 10 of the optical amplifier 600 is connected to a PD 722 and the PD 722 is connected to an input 739 of the control device 730. The main output 631 of the noise reduction apparatus 10 of the optical amplifier 600 is connected to an output tap coupler 740. The output tap coupler 740 is connected to a PD 723 and the PD 723 is connected to an input 741 of the control device 730. The output tap coupler 740 is also connected to an overall output 705 of the optical amplifier 700.

An input optical signal propagates to the tap coupler 710. The input tap coupler 710 performs an asymmetric split of the input optical signal such that a significant fraction of the input optical signal propagates to the gain block 620 and a small fraction of the input optical signal propagates to the PD 721. The input tap coupler 710 might have a splitting ratio of 95:5% for example. The significant fraction of the optical signal propagates to the gain block 620 where it is amplified resulting in an amplified optical signal with a coherent component of intensity, I_{C}, and an incoherent component of intensity, I_{N}. At the gain block 620, an amplified spontaneous emission (ASE) is generated, a component of which is all or part of the incoherent component of intensity, I_{N}, and a component of which, referred to as backward reflection, propagates in a backward direction to the input tap coupler 710. The tap coupler performs an asymmetric split of the backward reflection such that a fraction of the backward reflection propagates to the PD 720 which may provide information about the backward reflection power from the gain block 620 which may be of use in an optical networking system of which the amplifier would typically form a part. The amplified optical signal output by the gain block 620 propagates to the noise reduction apparatus 10. The noise reduction apparatus 10 produces a main output optical signal 602 at the main output 631 and one or more subsidiary output optical signals 604 at subsidiary outputs 632. The main output optical signal 602 propagates to the output tap coupler 740. The subsidiary output optical signal 604 propagates to the PD 722. The output tap coupler 740 performs an asymmetric split of the main output optical signal such that a significant fraction of the output optical signal propagates to the overall output 705 of the optical amplifier 700 and a small fraction of the output optical signal propagates to the PD 723. The splitting ratio may be 99:1% or example.

The control device 730 provides instructions to the noise reduction apparatus 10 for performing phase adjustments. The phase adjustments are described in the description of FIGS. 1 to 4. The control device 730 provides instructions to the noise reduction apparatus 10 such that the intensity of the output optical signal is maximised while the intensity of the subsidiary optical signal is minimised. Preferably, the control device 730 also provides instructions to control the power of the pump light supplied by the pump light source 610. Increasing the power of the pump light results in an increased gain of the input optical signal or in an increased output power of the signals. Therefore, the control device 730 controls the power of the pump light supplied by the pump light source 610 such that the performance of the optical amplifier satisfies any specified requirements, for example those of an optical networking systems.

The PDs 720,721,722,723 convert optical signals into electrical signals. The PD 720 converts the small fraction of the backward reflection from the gain block 620 into an electrical signal that is sent to the control device 730 providing information on the backward reflection power. The PD 721 converts the small fraction of the input optical signal from input 703 into an electrical signal that is sent to the control device 730 providing information on the intensity of input optical signal. The PD 722 converts the subsidiary output optical signal 604 into an electrical signal that is sent to the control device 730 providing information on the intensity of the subsidiary output optical signal 604. The PD 723 converts the small fraction of the main output optical signal 602 into an electrical signal that is sent to the control device 730 providing information on the intensity of the main output optical signal 602.

Typically, PDs 720,721 and 723 would be made use of by the optical networking system. PD 722 is used for the purpose of the noise reduction apparatus 10 to get the right optical path length difference. For example, the optical path length difference may be tuned until the power detected by the PD 722 is a minimum. In that state, assuming the requirement that the incoherent components are uncorrelated has been satisfied, all of the coherent signal power will be output at the main output 631, with only incoherent power being output at the subsidiary output 632. Any suitable control model may be used to hone in on a suitable optical path length difference on the basis of the output of PD 722.

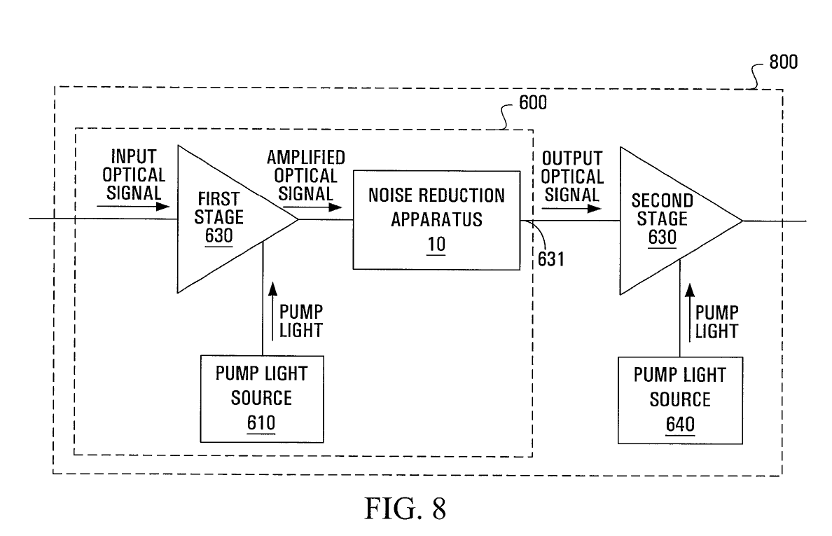

Referring to FIG. 8, shown is a schematic block diagram illustrating a very low NF two-stage optical amplifier 800 provided by another embodiment of the invention. The two-stage optical amplifier 800 includes a first stage amplifier 620 having pump light source 610 and a second stage amplifier 630 having pump light source 640. The output of the second stage amplifier 630 is connected to the main output 631 of the noise reduction apparatus 10 of the optical amplifier 600. Usually, for a multi-sage amplifier, the first stage determines the noise figure of the whole amplifier, and the second stage determines the gain and saturated output power of the whole amplifier. The total noise figure may be expressed as total NF=NF1+NF2/G1, where NF1 and NF2 are the noise figures of the first and seconds stages alone, and G1 is the gain of the first stage.

An input optical signal input to the first stage amplifier 620 is amplified through the first stage optical amplifier 620 and its SNR is increased through the noise reduction apparatus 10 resulting in an output optical signal at the main output 631. The output optical signal then propagates to the second stage amplifier 630. The pump light source 640 provides pump light to the second stage amplifier 630 resulting in amplification of the output optical signal without increasing the noise figure of the whole amplifier 800.

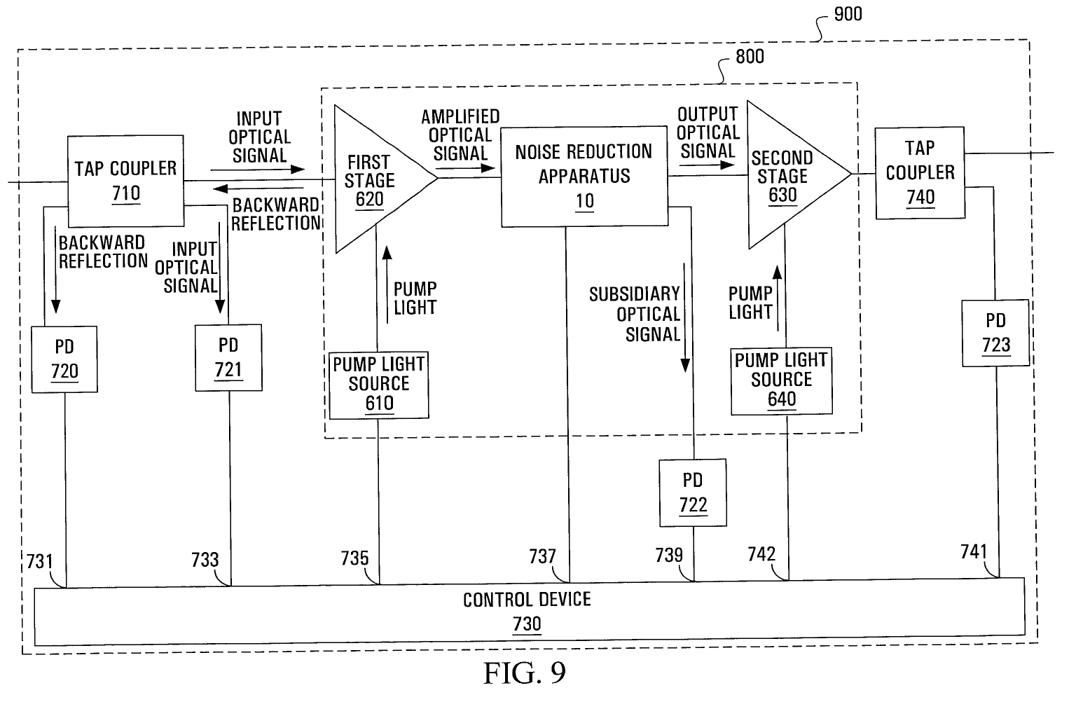

Referring to FIG. 9, shown is a schematic block diagram illustrating a very low NF two-stage optical amplifier 900 which includes the two-stage optical amplifier 800 and a control mechanism for tuning the performance of the optical amplifier 800 of FIG. 8. The two-stage optical amplifier 900 is similar to the optical amplifier 700 described with reference to FIG. 7 except that the optical amplifier 600 of the optical amplifier 700 has been replaced by the two-stage optical amplifier 800, and there is an output 742 of the control device 730 for controlling the pump light source 640. Once again, typically the output of power detector 722 is used by the control device to tune the optical path length difference for the best performance.

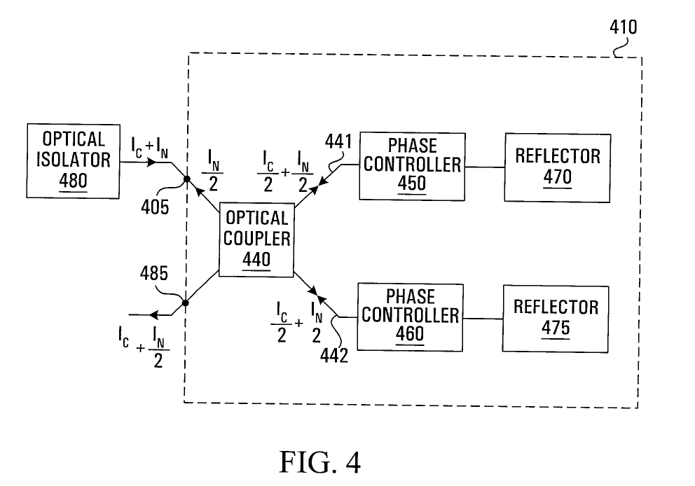

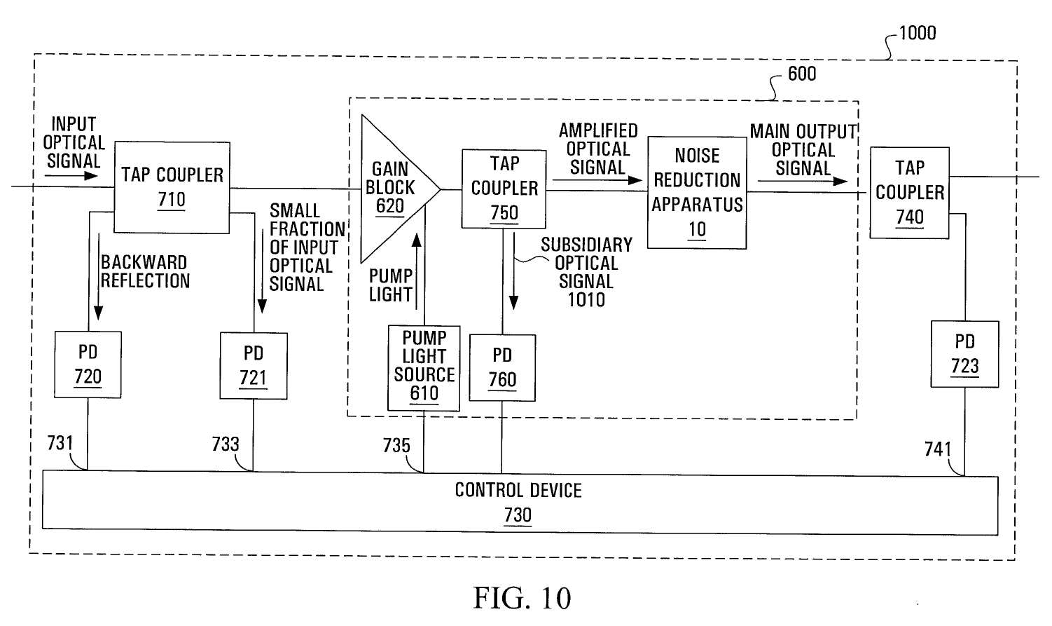

Referring to FIG. 10, shown is a schematic block diagram illustrating a very low NF optical amplifier 1000 provided by another embodiment of the invention. The optical amplifier 1000 is similar to the optical amplifier 700 of FIG. 7 except that a subsidiary optical signal 1010 is output backwards from the noise reduction apparatus 10 of FIG. 10 when compared to the subsidiary optical signal 604 of the optical amplifier 700 being output at the subsidiary output 632. Consequently there is a tap coupler 750 and power detector 760 which together provide a power indication to the control device 730, and an indication of how much power is in a subsidiary output. This would be the case for example for a Michelson interferometer-based noise reduction apparatus described below with reference to FIG. 4. The function of the optical amplifier 1000 is similar to that of the optical amplifier 700 of FIG. 7 except that the control device makes use of the intensity of the output of power detector 760 to adjust the optical path length.

Referring to FIG. 1, shown is a schematic block diagram illustrating a noise reduction apparatus 10, which is suitable for both single and multi-channel optical systems. The noise reduction apparatus 10 has an input 5 connected to an input optical splitter 40 having one input and two outputs (for example, a 1×2 coupler). The two outputs of the input optical splitter 40 are connected to respective inputs of an output optical coupler 70 through first and second optical transmission media 41,42 respectively. The output optical coupler 70 has two inputs, a main output 85, and a subsidiary output, 81 (for example a 2×2 coupler). The optical transmission media 41 and 42 are equipped with respective phase controllers 50 and 60. The main output 85 of the output optical coupler 70 constitutes the output of the noise reduction apparatus 10. The subsidiary output 81 of the output optical coupler 70 is terminated locally.

The noise reduction apparatus 10 of FIG. 1 reduces noise by exploiting the coherence of an optical signal and the incoherence of the noise within the optical signal. In particular, according to the invention, an input optical signal S_{IN}, which includes a coherent component having intensity I_{C} and an incoherent component (the noise) having intensity I_{N}, is split by the input optical splitter 40 into two path signals S₁,S₂ that propagate along the optical transmission media 41,42 respectively. By “incoherent component” it is meant generally any unwanted component of the input signal Sin which can be reduced in power by the apparatus 10, typically noise. Each path signal S₁,S₂ has a respective coherent path component having intensity I_{C}/2 and a respective incoherent (noise) path component having intensity I_{N}/2. The phase difference in the optical path lengths of the two optical transmission media 41,42, including the effects of the phase controllers 50,60 and including the effect of the input optical splitter 40, is selected such that path signal S₁ propagating in optical transmission medium 41 experiences a delay in time, Δt, compared with the path signal S₂ propagating in transmission medium 42. This delay in time is equivalent to a relative phase spread for coherent signals. According to the invention, this relative phase spread is chosen such that the coherent path component of the signal propagating through optical transmission medium 42 is almost completely coupled by output optical coupler 70 together with the coherent path component of the signal propagating through optical transmission medium 41 to the main output 85 in a manner that the two coherent path components interfere constructively and experience minimal loss. At the same time, the incoherent path components (the noise) of the two path signals S₁,S₂ become substantially uncorrelated with one another and couple equally into the main output 85 and the subsidiary output 81. The coherent signal power remains largely unaffected during the process of splitting and combining the two path signals with almost all of the coherent signal power being reproduced at the main output 85. On the other hand, the splitting and combining of the incoherent path component results in it being split approximately evenly between the main output 85 and the subsidiary output 81. This results in a much lower noise level and consequently results in a dramatic increase in the signal-to-noise ratio (SNR).

Theory of the Invention

At a combination point that exists at the output optical coupler 70, consider the case where there are two linearly polarized plane waves of the same wavelength, given by

\vec{E₁}(\vec{r},t)=\vec{E₀₁} Cos[ωt−ω₁(\vec{r})−φ₀₁] (2)

\vec{E₂}(\vec{r},t)=\vec{E₀₂} Cos[ωt−φ₂(\vec{r})−φ₀₂] (3)

which have propagated along the optical transmission media 41,42 and overlap at the combination point. The resultant field is simply

\vec{E}(\vec{r},t)=\vec{E₁}(\vec{r},t)+\vec{E₂}(\vec{r},t) (4)

neglecting a constant factor, the irradiance can be expressed as the time average of the total field:

I=<[\vec{E₁}(\vec{r},t)+\vec{E₂}(\vec{r},t)]·[\vec{E₁}(\vec{r},t)+\vec{E₂}(\vec{r},t)]>=I₁+I₂+I₁₂ (5)

where I₁=<\vec{E}₁²>, I₂=<\vec{E}₂²>, and I₁₂=2<\vec{E}₁·\vec{E}₂>=2\sqrt{I₁I₂} Cos δ, the last term being known as the interference term and δ=φ₁(\vec{r})−φ₂(\vec{r})+φ₁₀-φ₂₀ being the phase difference in the plane waves at the combination point. The φ₁(\vec{r})−φ₂(\vec{r}) contribution to the phase difference is due to the above discussed relative phase spread experienced by the path signal S₁ compared to the path signal S₂. The φ₁₀−φ₂₀ contribution is due to an initial phase difference at the initial point introduced by input optical splitter 40. When φ₁₀−φ₂₀ is constant, the linearly polarized plane waves are said to be coherent. For coherent waves, the overall phase difference δ is expressible as δ=2πfΔt where Δt is the delay in time between the two optical transmission media 41,42 including the effects of the phase controllers 50,60 and the splitter 40. On the other hand, if the two waves are incoherent as is the case with incoherent path components in particular, they do not have a constant phase difference but rather have an “effective phase difference δ” which varies randomly and rapidly as compared to the measuring time (in other words, an incoherent signal is substantially uncorrelated with itself a constant time later). The term “effective phase difference” is used because it does not really make sense to refer to the phase of such incoherent components. The interference term I₁₂ is reduced to zero for such incoherent waves. Based on the above analysis, for coherent waves, when Cos δ=1, i.e. when δ=0, ±2π, ±4π, . . . , the irradiance I at the combination point has the maximum value Iₘₐₓ=I₁+I₂+2\sqrt{I₁I₂}. For incoherent waves, the irradiance I at the overlap point is always constant value I=I₁+I₂. For now, a simple rule will suffice: if the overlapping waves are coherent, their fields can combine with each other in a sustained fashion and will be added first and then squared to yield the irradiance. If the waves are incoherent, the individual fields, which are effectively independent, will be squared first and then these component irradiances added.

Another way of summarizing the behaviour is to look at the power transfer function of the apparatus of FIG. 1 which can be summarized as:

Main output=[cos²(δ/2)]input

Subsidiary output=[sin²(δ/2)]input

For a random phase difference δ such as is effectively the case for incoherent path components, the above can be time averaged and expressed as:

Main output=input/2

Subsidiary output=input/2

For a phase difference selected to satisfy, for the coherent path components, cos(δ/2)=±1, i.e., when δ=0, ±2π, ±4π, . . . , the transfer function can be time averaged and expressed as:

Main output=input

Subsidiary output=0.

The present invention can be used to reduce noise power by 3-dB. At the same time, the power of the coherent component of the input optical signal remains almost the same. Eventually, the signal-to-noise ratio of the input signal is increased by a factor of 2.

The individual components of FIG. 1 will now be described in further detail.

Input Optical Coupler

The function of the input optical splitter 40 is to split the input optical signal with intensity, I, at its input into two path signals having the same intensity, I/2, but varying by a phase difference, φ₁₀−φ₂₀. In a preferred embodiment of the invention, the input optical splitter 40 is a 1×2 3-dB single-mode fiber coupler, for example a fused-fiber coupler. In another embodiment of the invention, the input optical splitter 40 is a 2×2 3-dB single-mode fiber coupler. In embodiments of the invention in which the input optical splitter 40 is a 2×2 3-dB single-mode fiber coupler, the input optical signal is input at one of the two inputs of the 2×2 3-dB single-mode fiber coupler and the other input of the 2×2 3-dB single-mode fiber coupler is terminated. In other embodiments of the invention, the input optical splitter 40 is a micro-optical coupler or any type of optical device capable of producing the required function.

Optical Transmission Media

In the preferred embodiment of FIG. 1, the optical transmission media 41 and 42 are optical fibers. In another embodiment of FIG. 1, the optical transmission media 41 and 42 are waveguides. An optical signal that propagates through the optical transmission medium 41 undergoes a phase spread, φ₁(\vec{r}). Similarly, another optical signal that propagates through the transmission medium 42 undergoes a phase spread, φ₂(\vec{r}). The phase controllers 50 and 60 are used to fine tune the phase spreads φ₁(\vec{r}), φ₂(\vec{r}) respectively.

A phase difference, φ₁(\vec{r})-φ₂(\vec{r}) is introduced partially by the optical transmission media 41,42 per se and partially by the phase spreads introduced by the phase controllers 50,60. The component introduced by the optical transmission media 41,42 per se may be due to different physical lengths of the media and/or different indexes of refraction of the media. Recalling that the overall phase difference at the combination point (the output optical coupler 70) can be expressed as φ₁(\vec{r})−φ₂(\vec{r})+φ₁₀−φ₂₀, a coarse phase adjustment of the phase difference, φ₁(\vec{r})_31 φ₂(\vec{r})+φ₁₀−φ₂₀ can be achieved by first choosing different respective physical lengths of the optical transmission media 41 and 42 and/or by using lengths of optical transmission media having different respective nominal index of refraction. Fine adjustment of the overall phase difference φ₁(\vec{r})−φ₂(\vec{r})+φ₁₀−φ₂₀ is performed using the phase controllers 50,60.

Phase Controllers

The phase controllers 50,60 may be any devices capable of introducing in a controllable manner the required fine phase spread into the overall phase spread experienced by signals propagating in the optical transmission media 41,42. In one embodiment of the invention, the phase controllers 50 and 60 are heaters and the fine phase adjustment is done by changing the indexes of refraction of at least portions of the optical transmission media 41 and 42 by heating one or both of the optical transmission media 41 and 42.

In another embodiment, the phase controllers 50,60 are adapted to apply a stretching force to at least portions of one or both of the optical transmission media 41 and 42. This can be achieved for example through the use of piezo-electric devices.

In the embodiment of FIG. 1, the fine phase spread is implemented through a combination of the two phase controllers 50 and 60. In another embodiment, the fine phase spread is implemented through the use of only a single phase controller, for example phase controller 50 in which case phase controller 60 is not required. However, it is noted that the use of both phase controllers 50 and 60 allows the phase difference to be finely adjusted with more ease and accuracy.

In a preferred embodiment of the invention each one of the optical transmission media 41 and 42 has a constant nominal index of refraction throughout its length. Nominally, ΔLₒ=n₁L₁−n₂L₂ where L₁ and L₂ are the physical lengths of the optical transmission media 41 and 42, respectively, and n₁ and n₂ are the indices of refraction of the optical transmission media 41 and 42, respectively. In another embodiment of the invention the indices of refraction of the optical transmission media 41 and 42 vary over the length of their respective medium. Consequently, ΔLₒ=∫n₁(s₁)ds₁−∫n₂(s₂)ds₂. For example, each path may have a number of segments each having a length and each having an index of refraction in which case

$$Δ {L}_{o} = {\sum }_{i = 1}^{{N}_{1}} {}_{i}^{}{n}{}_{1}^{} {}_{i}^{}{L}{}_{1 -}^{} {\sum }_{i = 2}^{{N}_{2}} {}_{i}^{}{n}{}_{2}^{} {}_{i}^{}{L}{}_{2}^{}$$

where one of the optical transmission media 41,42 is composed of N₁ segments with the i^{th} segment having indices of refraction and lengths {ᵢn₁, ᵢL₁}. Similarly, the other optical transmission medium of the optical transmission media 41,42 is composed of N₂ segments with the i^{th} segment having indices of refraction and lengths {ᵢn₂, ᵢL₂}. In this case, the fine phase control can be achieved through appropriate adjustment of any one or more of the indices of refraction ᵢn₁, ᵢn₂ and/or lengths ᵢL₁, ᵢL₂. Furthermore, the indices of refraction may vary continuously from one segment to another and/or within a segment in which case the above presented integral representation of ΔLₒ is a more accurate representation.

Any deviations in the optical path length difference ΔLₒ from p2π will result in some of the coherent signal power being output at subsidiary output 81 and lost.

Output Optical Coupler

The output optical coupler 70 is used as a combination point for combining two path signals each with intensity, I/2, but having a phase difference, δ, between the coherent path components at its two inputs. As indicated previously, the time-averaged intensity of the coherent path component of the output optical signal at the main output of the output optical coupler 70 is I<cos²(δ/2)>. Therefore, two coherent path signals at the first and second inputs of the output optical coupler 70 that have a constant phase difference, δ=±2pπ where p=0, ±1, ±2, . . . , are coupled entirely into the main output 85 of the output optical coupler 70 with intensity I, with no coherent signal strength being output at the subsidiary output 81. On the other hand, two independent incoherent optical signals have an effective phase difference, δ, which is a random function of time. In this case the two independent incoherent optical signals are coupled equally into the main output 85 and the subsidiary output 81, each with intensity I/2. In the preferred embodiment of FIG. 1, the output coupler 70 is a 2×2 3-dB single-mode fiber coupler with a 50:50 coupling ratio. More generally, any coupling device capable of combining the coherent components, and splitting off incoherent components to subsidiary outputs may be employed.

Design Constraints

The coherent and incoherent path components of the path signals that propagate through the transmission media 41,42 end up with a phase difference of φ₁(\vec{r})−φ₂(\vec{r})+φ₁₀−φ₂₀. The selection of this phase difference is made to ensure that the incoherent path components of the two path signals are not correlated at the point where recombination is to take place and to ensure that the coherent components combine constructively. The phase difference can be expressed as an optical path length difference, ΔLₒ.

A) Incoherence Length

Preferably, to ensure the incoherent path components are substantially uncorrelated, the optical path length difference, ΔLₒ, is selected to be greater than the coherence length, L_{c}, of the incoherent path components of the path signals (ΔLₒ>L_{c}). The choice ΔLₒ>L_{c} assures that the incoherent path components of the two path signals are independent and thus have a random phase difference between them and ensures that any incoherent path components are split approximately evenly between the main and subsidiary outputs of the output optical coupler. If ΔLₒ is less than L_{C}, then it is possible that some fraction less than 50% of the incoherent component will be directed to the subsidiary output. This will reduce the SNR improvement, but may still yield a workable design.

Constructive Combination

The optical path length difference, ΔLₒ, expressed as a phase difference is φ₁(\vec{r})−φ₂(\vec{r})+φ₁₀−φ₂₀. This quantity is selected such that the phase difference satisfies φ₁(\vec{r})−φ₂(\vec{r})+φ₁₀−φ₂₀=2pπ where p=0, ±1, ÷2, . . . , for the wavelength(s) of interest with the result that the coherent path components are coupled into the output 85 and combined constructively. While there are many phase differences that satisfy 2pπ, p=±1, ±2, . . . , some of these are eliminated for failing to satisfy the coherence length constraint. Typically, the coherence length constraint requires the phase difference to satisfy 2pπ, where p is an integer with |p|>Pₘᵢₙ.

The intensity of the coherent component of the output signal is equal to the intensity of the coherent component of the input signal except for minor insertion losses in the input and output couplers 40 and 70, respectively, and the two phase controllers 50 and 60. On the other hand, the intensity of the incoherent component of the output optical signal is approximately one-half the intensity of the incoherent component of the input optical signal. Consequently, the SNR of the input optical signal is therefore increased by a factor of approximately 2.

B) Symbol Spread Tolerance

When the coherent components are split and then recombined, one of the coherent components is delayed with respect to the other. This results in a slight spreading of the symbols being carried by the recombined coherent component. The symbol rate applies another condition which limits the optical path length difference to ΔLₒ≦χC/R, where C is the speed of light in vacuum; R is the symbol rate of the optical signals and χ is a fraction indicating a maximum symbol spread to which the system is tolerant. For example, χ=0.2 indicates a 20% tolerance. This requirement is put in place to avoid the effects of smearing/dispersion which would result should the coherent components be so different in phase that a substantial symbol spread occurs.

Multi-Channel Applications

For single wavelength applications, the case in which the SNR of the input optical signal is increased by a factor of approximately 2 requires that δ=2pπ where p=0, ±1, ±2, . . . ,. The method can also be used in multi-channel applications, in which case the input optical signal has a plurality of equally spaced (with respect to frequency) channels wherein any two consecutive channels with input wavelengths λ′ and λ differing by a spectral difference, Δλ=λ′−λ. To ensure the constructive recombination of all the wavelengths simultaneously at the combination point, the method requires that the optical path length difference, ΔLₒ, satisfies ΔLₒ=^{Kλλ′}/2(66 λ), where K=1, 2, 3, . . . . Equivalently, this condition is satisfied by two consecutive channels of frequency f′ and f simultaneously when ΔLₒ=KC/(2Δf), where K=1, 2, 3, . . . , C is the speed of light in vacuum and Δf=f′−f. Therefore, the noise reduction apparatus 10 separates a number of periodically spaced channels of the input optical signal at its input 5 and outputs the respective channels at its output 85 with each channel having an increase in SNR by a factor of approximately 2. For example, a channel space of 100 GHz around λ=1550-nm with an optical path length difference of 1 mm, 2 mm, 3 mm, 4 mm or 5 mm is practical and satisfies OC192 networking systems. If the optical path length difference, ΔLₒ, is too long OC192 networking systems requirements are not satisfied. The optical path length difference, ΔLₒ, may also be chosen to be approximately equal to 1 mm or less to satisfy requirements of future OC768 networking systems.

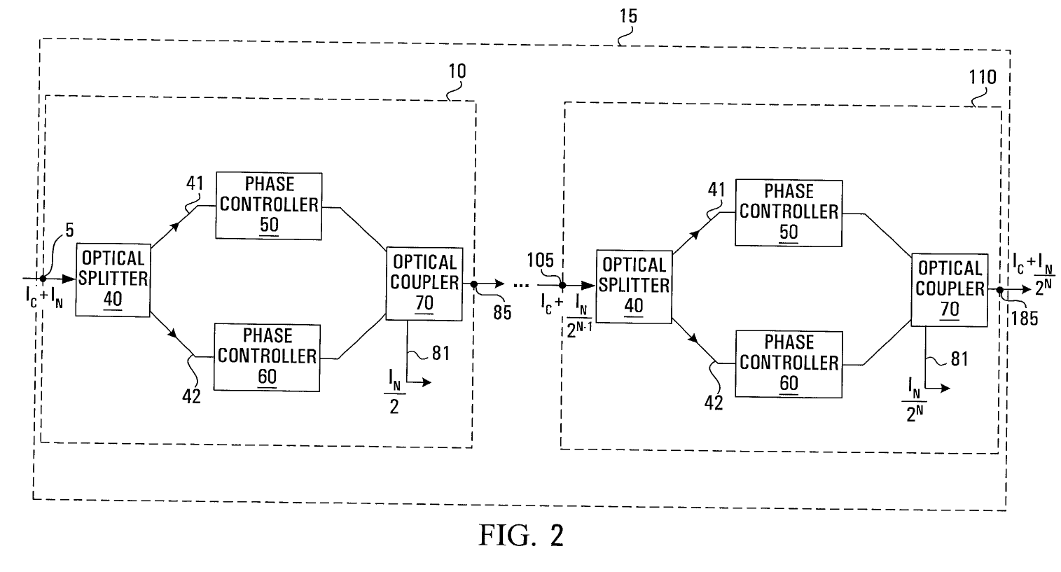

Referring to FIG. 2, shown is a noise reduction apparatus 15 provided by a second embodiment of the invention. The noise reduction apparatus 15 includes N noise reduction apparatuses 10,110 (only two shown), which are each similar to the noise reduction apparatus 10 of FIG. 1. The N noise reduction apparatuses are connected in series such that an output of one of the N noise reduction apparatuses is connected to an input of a consecutive noise reduction apparatus of the N noise reduction apparatuses. A final noise reduction apparatus 110 of the N noise reduction apparatuses has an output 185 which corresponds to an output of the noise reduction apparatus 15.

An input optical signal is input at the input 5 and propagates through the N noise reduction apparatuses, two of which are the apparatuses 10 and 110, and is output at the output 185. The intensity of a coherent component of the input optical signal remains largely unaffected at the output 185. On the other hand, the intensity of a incoherent component of the input optical signal is decreased by a factor of approximately 2^{N} at the output 185. Consequently, the SNR of the input optical signal is increased by a factor of approximately 2^{N}, or 3N dB.

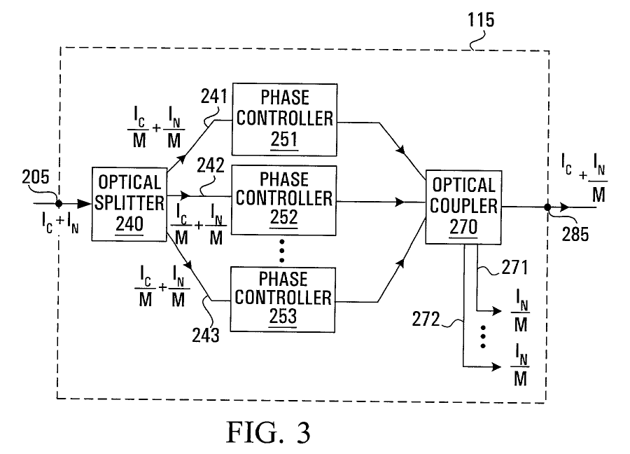

Referring to FIG. 3, shown is a noise reduction apparatus 115 provided by a third embodiment of the invention. The noise reduction apparatus 115 has an input 205 connected to an input optical splitter 240. In the preferred embodiment of FIG. 3, the input optical splitter 240 is a 1×M coupler and has one input and M outputs (only three shown). In another embodiment of FIG. 3, the input optical splitter 240 is an M×M coupler and has M inputs and M outputs. There are M optical transmission media (only three shown), three of which are optical transmission media 241, 242 and 243. Each one of the M optical transmission media is connected between one of the M outputs of the input optical splitter 240 and one of M inputs (only three shown) of an output coupler 270. The optical lengths of the M optical transmission media are chosen such that the optical path length difference, ΔLₒ, between any two of the M optical transmission media is greater than the coherence length, L_{c}, of incoherent path components of M path signals propagating through the respective M optical transmission media. Each one of the M transmission media passes through a phase controller (only three shown). The optical transmission media 241, 242 and 243 pass through phase controllers 251, 252 and 253, respectively. The output optical coupler 270 is a M×M coupler that has M outputs (only three shown) one of which is the main output 285 of the noise reduction apparatus 115. The remaining M−1 outputs 271, 272 are subsidiary outputs terminated locally (only two shown). The outputs 271 and 272 are terminated locally.

In the preferred embodiment of FIG. 3, each one of the M optical transmission media passes through a respective one of the M phase controllers. In another embodiment of FIG. 3, there are M−1 phase controllers and all but one of the M optical transmission media passes through a respective one of the M−1 phase controllers. Preferably, there is at least one phase controller.

In the preferred embodiment of FIG. 3, an input optical signal is input at the input 205. The input optical signal has a coherent component and an incoherent component (noise) with intensities, I_{C} and I_{N}, respectively. The input optical splitter 240 splits the input optical signal into M path signals. Each one of the M path signals has a coherent and incoherent path component. The coherent path components of the path signals have the same intensity, I_{C}/M, but vary in phase with a phase difference, φᵢ₀−φⱼ₀ where i, j=1, 2, . . . , M, between any two path signals of the M paths. Similarly, the incoherent path components of the two path signals have the same intensity, I_{N}/M. The coherent and incoherent path components of each of the path signals propagate through a respective one of the M optical transmission media and undergo a phase spread, φᵢ(\vec{r}) (i=1 to M). For example, the coherent and incoherent components of three path signals propagate through a respective one of the optical transmission media 241, 242 and 243 and undergo phase spreads, φ₁(\vec{r}), φ₂(\vec{r}) and φ₃(\vec{r}), respectively. The M phase controllers perform a fine phase adjustment of a phase φᵢ(\vec{r}) (i=1 to M) such that a phase difference, δ=φᵢ(\vec{r})−φⱼ(\vec{r})+φᵢ₀−φⱼ₀ (i, j=1 to M), between any two of the coherent path components of the M path signals satisfies δ=2pπ where p=0, ±1, ±2, . . . . After propagating through the M phase controllers the respective path signal then propagates to a respective input of the M inputs of the output optical coupler 270. At the output optical coupler 270 the coherent path components of the M path signals are combined constructively such that the intensity of a coherent component of an output optical signal at the output 285 is approximately equal to I_{C}. In addition, at the output optical coupler 270 the incoherent path components of the M path signals are coupled equally into the M outputs such that the intensity of the incoherent component of the output optical signal at the output 285 is approximately equal to I_{N}/M.

The intensity of the coherent component of the output optical signal is equal to the intensity of the coherent component of the input optical signal except for minor losses in the input optical splitter 240 and the coupler 270, respectively, the optical transmission media 41,42 and the M phase controllers. On the other hand, the intensity of the incoherent component of the output signal is reduced by a factor of approximately M of the intensity of the incoherent component of the input optical signal. Consequently, the SNR of the input optical signal is therefore increased by a factor of approximately M.

In another embodiment of FIG. 3, N noise reduction apparatuses similar to the noise reduction apparatus 115 are connected in series such that an output of one of the N noise reduction apparatuses is connected to an input of a consecutive noise reduction apparatuses of the N noise reduction apparatuses. In this embodiment, the SNR ratio of an input optical signal propagating through the N noise reduction apparatuses is increased by a factor of approximately M^{N} resulting in an increase in SNR of approximately 10N(logM)dB.

Referring to FIG. 4, shown is a noise reduction apparatus 410 provided by a fourth embodiment of the invention. The noise reduction apparatus 410 has an input 405 and an output 485. The input 405 and the output 485 are connected to a coupler 440. Optical transmission media 441 and 442 are connected to the coupler 440. The optical transmission media 441 and 442 are also connected to reflectors 470 and 475, respectively. In addition, the optical transmission media 441 and 442 pass through phase controllers 450 and 460. An optional optical isolator 480 is connected to the input 405 of the noise reduction apparatus 410.

In the preferred embodiment of FIG. 4, the coupler 440 is a 2×2 3-dB single-mode fiber coupler and the reflectors 470 and 475 are broadband fiber gratings. In another embodiment, the coupler 440 is a 2×2 single-mode micro-optics coupler and the reflectors 470 and 475 are different types of reflectors such as gold tip pig tail fiber reflectors.

In a preferred embodiment of the invention of FIG. 4, an input optical signal is input at the input 405. The input optical signal has a coherent component and an incoherent component with intensities, I_{C} and I_{N}, respectively. The coupler 440 splits the input optical signal into two path signals with each path signal having a coherent path component and incoherent path component with intensities, I_{C}/2 and I_{N}/2, respectively. The coherent path components of the two path signals have a phase difference, φ₁₀−φ₂₀, which is a constant whereas the incoherent path components of the two path signals have a phase difference, φ₁₀−φ₂₀, which is a random function of time. Each one of the two path signals performs a round trip propagating through its respective phase controller of the phase controllers 450 and 460 to its respective reflector of the reflectors 470 and 475 where it is reflected; and back through its respective phase controller of the phase controllers 450 and 460 to the coupler 440. A path signal of the two path signals that performs a round trip by passing through the phase controller 450 undergoes a phase adjustment, φ₁(\vec{r}) and a path signal of the two path signals that performs a round trip by passing through the phase controllers 460 undergoes a phase adjustment, φ₂(\vec{r}), resulting in a phase difference, φ₁(\vec{r})−φ₂(\vec{r}). An optical path length difference, ΔLₒ, associated with the phase difference, φ₁(\vec{r})−φ₂(\vec{r}), is selected to be greater than the coherence length, L_{c}, of the incoherent components of the path signals. After a round trip the two path signals each have coherent path components with intensity, I_{C}/2, and incoherent path components with intensity, I_{N}/2 at the coupler 440. At the coupler 440 the coherent path components of the two path signals have a phase difference, δ=φ₁(\vec{r})−φ₂(\vec{r})+φ₁₀−φ₂₀=2pπ where p=0, ±1, ±2, . . . , whereas the effective phase difference, δ, between the incoherent path components of the two path signals, is a random function of time. The coupler 440 combines the two path signals into output optical signals that are output at output 485 and input 405.

The intensities of the coherent and incoherent path components of the output signal at output 485 are given by I_{C}<cos²(δ/2)> and I_{N}/2, respectively, and intensities of the coherent and incoherent path components of the output signal at input 405 are given by I_{C}<sin²(δ/2)> and I_{N}/2. The phase controllers 450 and 460 perform a fine phase adjustment such that δ=2pπ where p=0, ±1, ±2, . . . , at the coupler 440. Therefore, with proper tuning δ, at output 485, the coherent path components of the two path signals combine constructively with intensity, I_{C} at output 485 and input 405. Since the optical path length, ΔLₒ, is greater than the coherence length of the incoherent path components of the two path signals, they couple with intensity, I_{N}/2, into output 485 and input 405. Consequently, the SNR of the input optical signal at the input 405 is increased by a factor of approximately 2 at the output 485. The optional optical isolator 480 suppresses the output optical signal at the input 405.

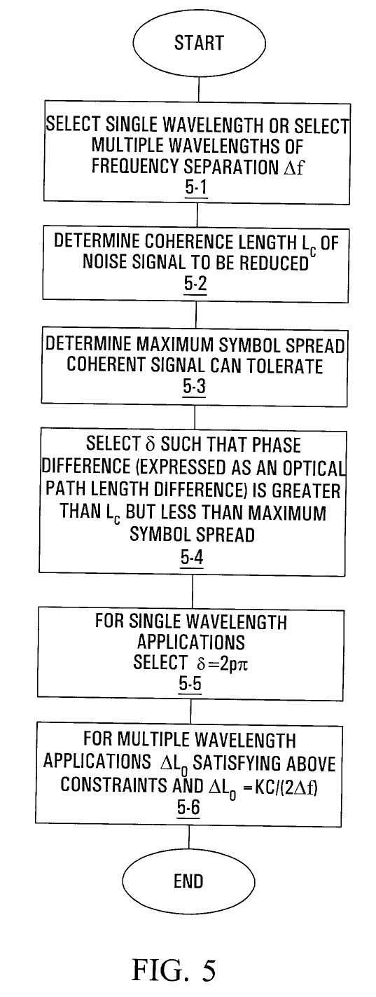

Referring to FIG. 5, shown is a flow chart of a preferred method of selecting a phase difference for use in the apparatus of FIG. 1. The method starts with the identification of a single wavelength of interest λ, or the identification of a set of wavelengths of interest having constant frequency spacing Δf between any two consecutive wavelengths (step 5-1). In the following steps the coherence length, L_{c}, of the M path signals is determined (step 5-2) and the maximum symbol spread the coherent path components can tolerate (step 5-3). An optical path length difference between any two coherent path components is selected by choosing a phase difference such that an optical path length difference, ΔLₒ, satisfies the following criteria: 1) ΔLₒ>L_{c} where L_{c} is a coherence length of the incoherent path components of the M path signals (step 5-4); 2) ΔLₒ selected for satisfactory symbol spread (step 5-4); 3) For single wavelength applications, a phase difference is selected associated with any two paths of the M path signals, resulting in a phase difference, δ=2pπ where p=0, ±1, ±2, . . . , between the coherent components of any two of the M path signals at a combination point (step 5-5); 4) For multiple wavelength applications, ΔLₒ=KC/(2Δf) (step 5-6) where, Δf=f′−f and, f′ and f are the frequencies of two consecutive channels of the input optical signal. For single wavelength applications, the simultaneous satisfaction of all the constraints involves the proper selection of p. To satisfy these three constraints simultaneously for multiple wavelength applications involves the proper selection of K.

In a preferred embodiment M=2 and N=1 resulting in an increase in the SNR of the input optical signal of approximately 2 and an increase in the SNR of approximately 3 dB.

In yet another way of implementing this invention, the noise reduction apparatus can be implemented with M paths, and within each of the M paths, a further noise reduction apparatus having Nᵢ paths may be provided to improve the SNR of a respective one of the M path signals.

Numerous modifications and variations of the present invention are possible in light of the above teachings. It is therefore to be understood that within the scope of the appended claims, the invention may be practised otherwise than as specifically described herein.

We claim:

1. A method of amplifying an input optical signal, the method comprising:
amplifying the input optical signal, resulting in an amplified optical signal having a coherent component and an incoherent component;
splitting the amplified optical signal into M path signals each having a respective coherent path component and a respective incoherent path component and wherein M satisfies M≧2;
applying a respective phase adjustment to at least one of the M path signals, wherein the phase adjustments are applied such that, at a combination point, the coherent path components are combinable constructively and each incoherent path component is substantially uncorrelated with each other incoherent path component; and
at the combination point, combining the M path signals to produce a main output optical signal with an improved SNR compared to the amplified optical signal.

2. A method according to claim 1 comprising applying a phase adjustment to at least M−1 of the M path signals.

3. A method according to claim 1 wherein the combining the M path signals comprising coupling the M path signals together in a manner which produces the main output optical signal containing most of the coherent signal power and containing a fraction of the incoherent signal power, with the remaining incoherent signal power being diverted to one or more subsidiary outputs.

4. A method according to claim 1 wherein the phase adjustments are achieved by employing an optical path length difference, ΔLₒ, between any two path signals of the M path signals, the optical path length difference substantially satisfying ΔLₒ>L_{c} wherein L_{c} is the coherence length of the incoherent path components of the M path signals.

5. A method according to claim 1 wherein M=2.

6. A method according to claim 1 wherein the splitting, the phase adjustment and the combining are iterated N times wherein N satisfies N≧2, resulting in a decrease in NF of approximately 10 NlogM dB.

7. A method according to claim 1 wherein a phase adjustment is applied to every one of the M path signals.

8. A method according to claim 4 wherein the optical path length difference substantially satisfies ΔLₒ≦χC/ω wherein C is the speed of light, ω is a carrier data rate of the input optical signal and χ is a symbol shift tolerance.

9. A method according to claim 4 wherein the optical path length difference, ΔLₒ, is chosen to satisfy a symbol shift tolerance.

10. A method according to claim 1 wherein the phase adjustment comprises passing the M path signals through respective different optical lengths of the optical transmission media.

11. A method according to claim 1 wherein the phase adjustment comprises applying a fine phase adjustment to at least one of the path signals.

12. A method according to claim 1 wherein the splitting, combining and phase adjustment are performed with a Mach-Zehnder interferometer-based structure.

13. A method according to claim 1 wherein the splitting, combining and phase adjustment are performed with a Michelson interferometer-based structure.

14. A method according to claim 1 applied to an optical signal comprising a plurality of equally spaced channels wherein any two consecutive channels with frequencies f′ and f of the equally spaced channels differing by Δf=f′−f, and wherein the optical path length difference, ΔLₒ, substantially satisfies ΔLₒ=KC/(2Δf), wherein K=1, 2, 3, . . . and C is the speed of light in vacuum.

15. A method according to claim 1 further comprising dynamically controlling the amplification of the input light signal to maximise the gain of the input optical signal without compromising the NF.

16. A method according to claim 1 further comprising dynamically controlling the phase adjustments to maximise the intensity of the output optical at the combination point.

17. A method according to claim 1 further comprising amplifying the main output optical signal through a subsequent amplification stage.

18. A method according to claim 17 further comprising dynamically controlling the amplifying the main output optical signal to maximise the gain of the input optical signal without compromising the NF of the optical amplifier.

19. An optical amplifier adapted to amplify an input optical signal, the optical amplifier comprising:
an amplification stage adapted to receive the input optical signal and amplify the input optical signal resulting in an amplified optical signal having a coherent component and an incoherent component;
a noise reduction apparatus connected to the amplification stage, the noise reduction apparatus being adapted to split the amplified optical signal into M path signals, each having a coherent path component and an incoherent path component, and to recombine the M path signals in a manner resulting in a decreased noise figure (NF) of the optical amplifier.

20. An optical amplifier according to claim 19 wherein an optical path length difference, ΔLₒ, between paths of any two path signal of the M path signals satisfies ΔLₒ>L_{c} wherein L_{c} is the coherence length of the incoherent path components.

21. An optical amplifier according to claim 19 wherein the amplification stage comprising a gain block adapted to receive the input optical signal and amplify the input optical signal resulting in the amplified optical signal.

22. An optical amplifier according to claim 21 wherein the gain block is a fiber amplifier.

23. An optical amplifier according to claim 21 wherein the amplification stage comprising a pump light source connected to the gain block, wherein the pump light source adapted to supply pump light to the gain block.

24. An optical amplifier according to claim 19 wherein the noise reduction apparatus comprising an input optical splitter connected to the amplification stage, the input optical splitter adapted to split the amplified optical signal into the M path signals, where M>=2.

25. An optical amplifier according to claim 24 wherein the input optical splitter is 1×M splitter.

26. An optical amplifier according to claim 24 wherein the input optical splitter is a M×M splitter wherein one of M inputs of the M×M splitter being adapted to receive the amplified optical signal and wherein remaining ones of the M inputs of the M×M splitter being locally terminated.

27. An optical amplifier according to claim 19 wherein the noise reduction apparatus comprising M optical transmission media, wherein each one of the M path signals propagates through a respective one of the M optical transmission media.

28. An optical amplifier according to claim 27 wherein the optical transmission media are optical wave-guides.

29. An optical amplifier according to claim 27 wherein the optical transmission media are optical fibers.

30. An optical amplifier according to claim 27 wherein the noise reduction apparatus comprising a phase controller in at least one of the M optical transmission media, wherein the phase controller adapted to apply a phase adjustment to a respective one of the path signals.

31. An optical amplifier according to claim 27 wherein the noise reduction apparatus comprising a phase controller in at least M−1 of the M optical transmission media, wherein the phase controllers adapted to apply a phase adjustment to a respective one of the path signals.

32. An optical amplifier according to claim 27 wherein the noise reduction apparatus comprising a phase controller in each one of the M optical transmission media, wherein the phase controllers adapted to apply a phase adjustment to a respective one of the path signals.

33. An optical amplifier according to claim 30 wherein the phase controllers comprising at least one heater adapted to introduce the phase adjustment by varying an index of refraction of a respective one of the optical transmission media through the application of heat.

34. An optical amplifier according to claim 30 wherein the phase controllers comprising at least one device adapted to introduce the phase adjustment by applying at stretching force to at least one of the optical transmission media to change the physical length of the transmission medium.

35. An optical amplifier according to claim 34 wherein the at least one device is a piezoelectric device.

36. An optical amplifier according to claim 19 wherein the noise reduction apparatus comprising an output optical coupler adapted to couple the path signals into a main output optical signal and at least one subsidiary output optical signal at a main output and at one or more subsidiary outputs, respectively, wherein substantially all of the coherent path components are output at the main output, while the incoherent path components are substantially divided between the main output and at least one of the one or more subsidiary outputs.

37. An optical amplifier according to claim 36 wherein the output optical coupler is a M×M coupler, wherein one of M outputs of the M×M coupler is the main output and remaining ones of the M outputs are the subsidiary outputs.

38. An optical amplifier according to claim 19 further comprising a subsequent amplification stage connected to an output of the noise reduction apparatus, the subsequent amplification stage being adapted to amplify the main output optical signal.

39. An optical amplifier according to claim 19 comprising a plurality of the noise reduction apparatuses arranged in a serial configuration.

40. An optical amplifier according to claim 39 wherein M=2 and the noise reduction apparatus results in a decrease in the NF of the optical amplifier of approximately 3 dB.

41. An optical amplifier according to claim 24 wherein the number of path signals satisfies M=2 and the input optical splitter is a 1×2 3-dB single-mode coupler.

42. An optical amplifier according to claim 24 wherein the number of path signals satisfies M=2 and the input optical splitter is a 2×2 3-dB single-mode coupler, wherein one of two inputs of the 2×2 3-dB single-mode coupler is terminated locally.

43. An optical amplifier according to claim 24 wherein the number of path signals satisfies M=2 and the output optical coupler is a 2×2 3-dB single-mode coupler.

44. An optical amplifier according to claim 27 wherein the number of path signals satisfies M=2 and the noise reduction apparatus further comprises two reflectors each connected to a respective one of the optical transmission media and adapted to reflect a respective one of the path signals.

45. An optical amplifier according to claim 44 wherein the n o is e reduction apparatus further comprises an optical coupler connected to the optical transmission media, wherein the optical coupler adapted to receive the input optical signal and split it into the path signals and adapted to receive and couple the path signals after being reflected by the reflectors.

46. An optical amplifier according to claim 44 wherein the reflectors are fiber Bragg gratings.

47. An optical amplifier according to claim 46 wherein the two reflectors are gold tip pig tail fiber reflectors.

48. An optical amplifier according to claim 47 wherein the optical coupler is a 2×2 3-dB single-mode coupler.

49. An optical amplifier according to claim 19 further comprising a control mechanism adapted to tune the performance of the optical amplifier.

50. An optical amplifier according to claim 49 wherein the control mechanism comprises a control device connected to the amplification stage and the noise reduction apparatus, the control device being adapted to provide instructions to the amplification stage for controlling the amplification of the input optical signal and to provide instructions to the noise reduction apparatus for controlling phase adjustments of the path signals.

51. An optical amplifier according to claim 50 wherein the control mechanism comprises an input tap coupler connected to the amplification stage and two power detectors (PDs) each connected to the input tap coupler and the control device, wherein the input tap coupler adapted to provide an asymmetric split of the input light signal such that a significant fraction of the input light signal propagates to the amplification stage and a small fraction of the input light signal propagates to a respective one of the PDs, and wherein a fraction of a backward reflection, produced by the gain block, propagating through the input tap coupler is routed to a respective one of the PDs.

52. An optical amplifier according to claim 49 wherein the input tap coupler is a 2×2 asymmetric coupler.

53. An optical amplifier according to claim 1 further comprising a power detector connected to at least one subsidiary output of the noise reduction apparatus and to the controlling device, the power detector adapted to convert a subsidiary optical signal into a signal representative of the power of the subsidiary optical signal.

54. An optical amplifier according to claim 53 wherein the controlling device is adapted to control at least one of the phase adjustments applied to the path signals as a function of the output of the power detector.

55. A two-stage optical amplifier comprising the optical amplifier of claim 1 and a subsequent amplification stage connected to an output of the noise reduction apparatus.
